(19) United States
(12) Patent Application Publication
(10) Pub. No.: US 2014/0029087 A1
(43) Pub. Date: Jan. 30, 2014

(54) SWITCHABLE LENS DEVICE, METHOD OF MANUFACTURING THE SAME, AND 2-DIMENSIONAL AND 3-DIMENSIONAL IMAGE DISPLAY DEVICE USING THE SAME

(71) Applicant: LG DISPLAY CO., LTD., Seoul (KR)

(72) Inventors: Ara Yoon, Seoul (KR); Sungwoo Kim, Paju-si (KR); Seungchul Lee, Goyang-si (KR)

(21) Appl. No.: 13/950,865

(22) Filed: Jul. 25, 2013

(30) Foreign Application Priority Data
Jul. 25, 2012 (KR) 10-2012-0081381
Jul. 9, 2013 (KR) 10-2013-0080405

(51) Int. Cl. G02B 27/22; G02B 13/14

(52) U.S. Cl. CPC G02B 27/2214; G02B 13/143
USPC 359/355; 359/463; 156/247

(57) ABSTRACT

A switchable lens device, a method of manufacturing the same, and a 2-dimensional (2D) and 3-dimensional (3D) image display device using the same are disclosed. The switchable lens device includes a first base film, a first lens layer which is formed on the first base film, has a first refractive index in a first direction, has a second refractive index less than the first refractive index in a second direction vertical to the first direction, and has concave surfaces, a second lens layer which has convex surfaces filled in the concave surfaces of the first lens layer and has the first refractive index, and a second base film attached to the second lens layer.

This application claims the benefit of priority under U.S.C §119(a) to Korea Patent Application No. 10-2012-0081381 filed on Jul. 25, 2012, and Korean Patent Application No. 10-2013-0080405 filed on Jul. 9, 2013, the contents of each of which are incorporated herein in their entirety.

### BACKGROUND

1. Field of the Disclosure

Embodiments of the disclosure relate to a switchable lens device, a method of manufacturing the same, and a 2-dimensional (2D) and 3-dimensional (3D) image display device using the same.

2. Discussion of the Related Art

A 3D image display device may be classified into one of a stereoscopic display device using glasses or an autostereoscopic display device called a glasses-free 3D display.

In general, the stereoscopic display device spatially separates an image into a left eye image and a right eye image and displays them, or separates the image into the left eye image and the right eye image in a time division manner and displays them. However, when a viewer watches a 3D image through the stereoscopic display device, the viewer feels inconvenient because he/she has to wear glasses. Hence, the autostereoscopic display device has been developed.

The autostereoscopic display device generally has optical elements, such as a parallax barrier and a lenticular lens, for separating optical axes of the left eye image and the right eye image, disposed in front of or behind a display screen, thereby implementing the 3D image.

However, such a related art autostereoscopic display device displays the 3D image, but has the problem not to display a 2D image.

### SUMMARY

A switchable lens device includes a first base film, a first lens layer which is formed on the first base film, has a first refractive index in a first direction, has a second refractive index less than the first refractive index in a second direction vertical to the first direction, and has concave surfaces, a second lens layer which has convex surfaces filled in the concave surfaces of the first lens layer and has the first refractive index, and a second base film attached to the second lens layer.

In another aspect, there is a 2D/3D image display device including a display panel configured to display an image using light linearly polarized in a first direction, a polarization control unit configured to selectively switch light of the first direction to light linearly polarized in a second direction vertical to the first direction, and a switchable lens device configured to refract light incident from the polarization control unit using a difference of a refractive index and separate the refracted light into light for a left eye image and light for a right eye image to implement a 3D image, or transmit the light incident from the polarization control unit without a change to implement a 2D image.

In yet another aspect, there is a method of manufacturing a switchable lens device including forming a first lens layer, which has a first refractive index in a first direction, has a second refractive index less than the first refractive index in a second direction vertical to the first direction, and has concave surfaces, on a first base film, filling a second lens layer having the first refractive index in the concave surfaces of the first lens layer to form convex surfaces, and forming a second base film on the second lens layer.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a cross-sectional view schematically showing configuration of a 2D/3D image display device according to an exemplary embodiment of the invention;

FIG. 2 is a cross-sectional view showing a polarization control unit of the 2D/3D image display device shown in FIG. 1;

FIGS. 3A and 3B are cross-sectional views illustrating a polarization direction of light depending on an operation state of the polarization control unit shown in FIG. 2;

FIG. 4 is a cross-sectional view showing a switchable lens device of the 2D/3D image display device shown in FIG. 1;

FIG. 5 illustrates a principle to converge light on a concave surface of the switchable lens device shown in FIG. 4;

FIG. 6 illustrates a principle to display a 2D image and a 3D image through a 2D/3D image display device according to an exemplary embodiment of the invention;

FIGS. 7A to 7F illustrate an example of a method of manufacturing a switchable lens device according to an exemplary embodiment of the invention; and

FIGS. 8A to 8D illustrate another example of a method of manufacturing a switchable lens device according to an exemplary embodiment of the invention.

### DETAILED DESCRIPTION OF THE EXEPMLARY EMBODIMENTS

Reference will now be made in detail to embodiments of the invention, examples of which are illustrated in the accompanying drawings. Wherever possible, the same reference numbers will be used throughout the drawings to refer to the same or like parts. It will be paid attention that detailed description of known arts will be omitted if it is determined that the arts can mislead the embodiments of the invention.

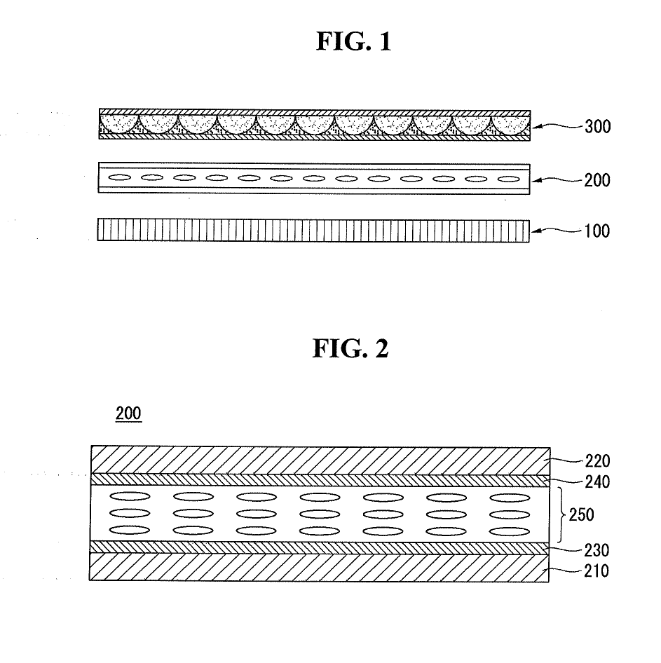

A 2-dimensional (2D) and 3-dimensional (3D) image display device according to an exemplary embodiment of the invention is described below with reference to FIG. 1. FIG. 1 is a cross-sectional view schematically showing configuration of a 2D/3D image display device according to an exemplary embodiment of the invention.

As shown in FIG. 1, the 2D/3D image display device according to the embodiment of the invention includes a display panel 100, a polarization control unit 200, and a switchable lens device 300. The display panel 100, the polarization control unit 200, and the switchable lens device 300 are disposed along a travelling path of light in the order named.

The display panel 100 is a display device displaying 2D image data and 3D image data. The display panel 100 includes a flat panel display, such as a liquid crystal display (LCD), a field emission display (FED), a plasma display panel (PDP), an electroluminescence device (EL) including an inorganic light emitting display and an organic light emitting display, and an electrophoresis display (EPD). In the following description, the embodiment of the invention will be described using the liquid crystal display as an example of the display panel 100. Other flat panel displays may be used.

The display panel 100 includes a thin film transistor (TFT) substrate on which a pixel array including TFTs is formed, a color filter substrate on which color filters representing colors are formed, and a liquid crystal layer disposed between the TFT substrate and the color filter substrate. Polarizing plates, of which light absorption axes form about 90° with each other, are respectively attached to the surfaces of the TFT substrate and the color filter substrate of the display panel 100. Hence, light incident on the display panel 100 in a horizontal direction or a vertical direction is linearly polarized in a direction forming about 90° with a light absorption axis of the incident light and then comes out of the display panel 100.

The polarization control unit 200 is disposed on the display panel 100. The polarization control unit 200 transmits light supplied from the display panel 100 without a change or linearly polarizes the light by about 90°, and then supplies the light to the switchable lens device 300. The polarization control unit 200 may be applied to a liquid crystal panel driven in a twisted nematic (TN) mode, a vertical alignment (VA) mode, an in-plane switching (IPS) mode, and a fringe field switching (FFS) mode.

The switchable lens device 300 is disposed on the polarization control unit 200. The switchable lens device 300 transmits light supplied from the polarization control unit 200 without a change to display a 2D image, or separates the light into light corresponding to a right eye image and light corresponding to a left eye image to display a 3D image, depending on a polarization direction of the light supplied from the polarization control unit 200.

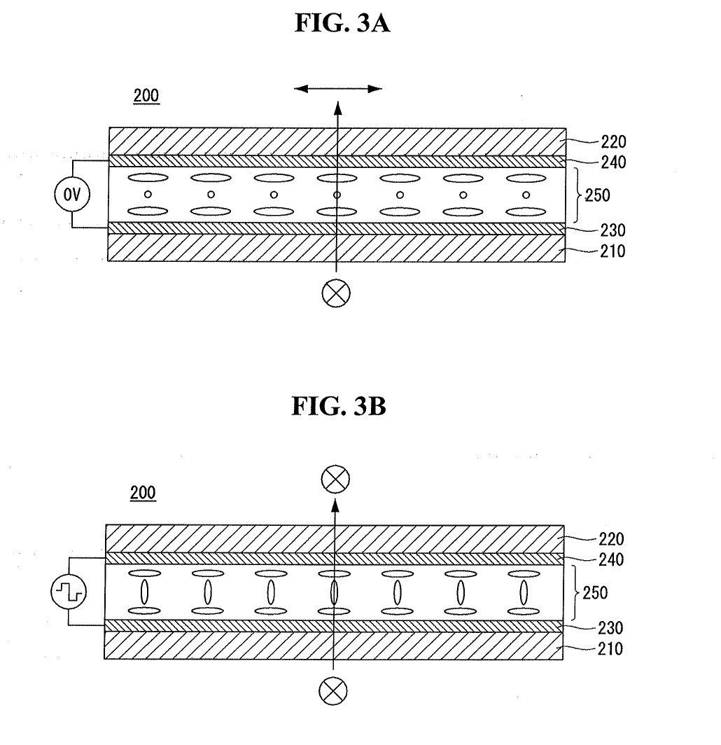

Configuration and operations of the polarization control unit 200 are below described with reference to FIGS. 2, 3A, and 3B. FIG. 2 is a cross-sectional view showing configuration of the polarization control unit 200 configured as a TN mode liquid crystal panel. FIGS. 3A and 3B are cross-sectional views illustrating a polarization direction of light depending on an operation state of the polarization control unit 200 shown in FIG. 2.

As shown in FIG. 2, the polarization control unit 200 includes a first electrode 230 formed on a first substrate 210 (corresponding to a lower substrate in FIG. 2), a second electrode 240 which is positioned opposite the first electrode 230 and is formed on a second substrate 220 (corresponding to an upper substrate in FIG. 2), and a liquid crystal layer 250 disposed between the first electrode 230 and the second electrode 240.

Each of the first substrate 210 and the second substrate 220 is formed of glass or transparent plastic.

Each of the first electrode 230 and the second electrode 240 is formed of a transparent conductive material such as indium tin oxide (ITO), indium zinc oxide (IZO), and gallium-doped zinc oxide (GZO).

Liquid crystal molecules configuring the liquid crystal layer 250 are formed of positive liquid crystals. The positive liquid crystals are liquid crystals defined by the fact (i.e., Δε>0) that a long axis direction permittivity (ε∥) of the liquid crystal molecules is greater than a short axis direction permittivity (ε⊥) of the liquid crystal molecules. The positive liquid crystals are arranged between alignment layers (not shown) respectively attached to the first electrode 230 and the second electrode 240 and are pre-tilted.

As shown in FIG. 3A, when an electric field is not applied to the liquid crystals in TN mode, the liquid crystals are arranged so that linear polarization of incident light in a vertical direction (indicated by ‘\hat{×}’) is rotated by about 90° and is changed to linear polarization of a horizontal direction (indicated by ‘←’). On the other hand, as shown in FIG. 3B, when an electric field is applied to the liquid crystals, the liquid crystals are arranged so that incident light is transmitted without a change. Hence, when the electric field is not applied to the liquid crystals as shown in FIG. 3A, the polarization control unit 200 linearly polarizes light having a polarization axis of the vertical direction ‘\hat{×}’ into light having a polarization axis of the horizontal direction ‘←’ and then transmits the light. When the electric field is applied to the liquid crystals as shown in FIG. 3B, the polarization control unit 200 transmits light having the polarization axis of the vertical direction ‘\hat{×}’ without a change, and thus a polarization axis of the transmitted light is the vertical direction.

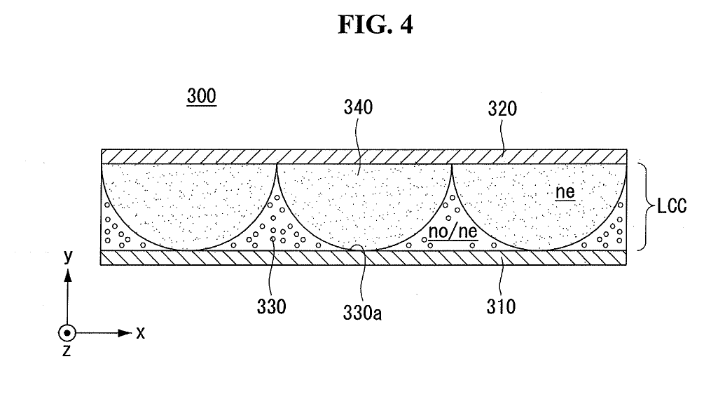

Next, the switchable lens device 300 of the 2D/3D image display device according to the embodiment of the invention is described with reference to FIG. 4. FIG. 4 is a cross-sectional view of the switchable lens device 300.

As shown in FIG. 4, the switchable lens device 300 includes a first film 310, a second film 320, and a lens cell LCC. The lens cell LCC is disposed between the first film 310 and the second film 320, and is formed by combining a first lens layer 330 having concave surfaces 330a and a second lens layer 340 having convex surfaces.

The first film 310 is formed of a material having a low retardation equal to or less than about 100 nm, and isotropic and uniaxial characteristics. For example, the first film 310 may be selected from a group including polyethylene terephthalate (PET), triacetyl cellulose (TAC), and polycarbonate (PC).

The first film 310 may secure a back distance required when the switchable lens device 300 is attached to the display panel 100. Thus, additional means for securing the distance between the display panel 100 and the switchable lens device 300 is not necessary.

Further, because the first film 310 has the low retardation, the first film 310 does not recognize a retardation of light emitted from the display panel 100. Hence, the first film 310 may prevent a reduction in a 3D crosstalk characteristics.

The second film 320 may be formed of the same material as the first film 310. For example, the second film 320 may be formed of polyethylene terephthalate (PET), triacetyl cellulose (TAC), and polycarbonate (PC). Alternatively, the second film 320 may be formed of a different material from the first film 310.

The first lens layer 330 is formed by curing ultraviolet (UV) curable liquid crystals in a state where the UV curable liquid crystals are orientated in a vertical direction (z-axis direction in FIG. 4), and has successive concave surfaces 330a. Thus, liquid crystals configuring the first lens layer 330 permanently maintain a form in which the liquid crystals are orientated in the vertical direction at all of positions. More specifically, molecules of the UV curable liquid crystals, reactive mesogen, form a network by a light reaction and may maintain an initial orientation of liquid crystal molecules. Thus, when polarized UV ray is irradiated onto the UV curable liquid crystals, the UV curable liquid crystals are cured while maintaining the initial orientation state in conformity with polarized light of the UV ray. Hence, the first lens layer 330 is formed.

The first lens layer 330 has a first refractive index ‘ne’ and a second refractive index ‘no’ depending on a direction of liquid crystal molecule because of refractive index anisotropy of the liquid crystal molecule. More specifically, the first lens layer 330 has the first refractive index ‘ne’ in a long axis direction of the liquid crystal molecule, but has the second refractive index ‘no’ which is smaller than the first refractive index ‘ne’ in a short axis direction of the liquid crystal molecule. Because a long axis of the liquid crystal molecules of the first lens layer 330 according to the embodiment of the invention is arranged in the same direction as the vertical direction (z-axis direction in FIG. 4), the first lens layer 330 has the first refractive index ‘ne’ in the vertical direction. Further, because a short axis of the liquid crystal molecules of the first lens layer 330 is arranged in the same direction as a horizontal direction (x-axis direction in FIG. 4), the first lens layer 330 has the second refractive index ‘no’ in the horizontal direction.

The second lens layer 340 is formed in the concave surfaces 330a so as to flatly cover the concave surfaces 330a of the first lens layer 330. The second lens layer 340 may be formed of a transparent resin and has the same refractive index (i.e., first refractive index ‘ne’) as the refractive index in the long axis direction of the first lens layer 330.

Because the material for forming the first lens layer 330 of the switchable lens device 300 having the above-described configuration may be reduced, the manufacturing cost may be reduced. As shown in FIG. 4, because the first lens layer 330 is formed in a concave lens shape, a volume of the first lens layer 330 may be equal to or less than about one quarter of a volume of the second lens layer 340 having a convex lens shape. While the reactive mesogen forming the first lens layer 330 amounts to 1 to 2 dollars per gram, a UV curable resin forming the second lens layer 340 amounts to 0.05 dollar per gram and is much cheaper than the reactive mesogen. In the embodiment of the invention, the volume of the first lens layer 330 is much less than the volume of the second lens layer 340, and the second lens layer 340 having the relatively large volume is formed of the cheap UV curable resin. Thus, the manufacturing cost may be reduced.

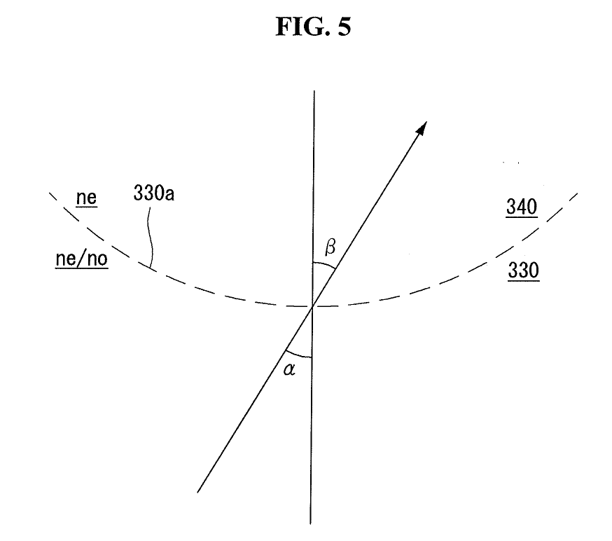

FIG. 5 illustrates conditions for converging light on a focus of the switchable lens device 300. To display the 3D image, light has to be divided into light for a left eye image and light for a right eye image by the switchable lens device 300, and the light for the left eye image and the light for the right eye image have to be converged on a focus of the switchable lens device 300.

As described above, the first lens layer 330 has the first refractive index ‘ne’ and the second refractive index ‘no’ depending on a polarization direction of light, and the second lens layer 340 has the first refractive index ‘ne’.

According to Snell's law, when light passes through two different media each having a different refractive index, an incident angle a and a refractive angle β of the light at a boundary between the two media hav.e a relationship of no.sinα=ne.sinβ. However, because the second refractive index ‘no’ is less than the first refractive index ‘ne’, the incident angle a has to be greater than the refractive angle β so as to satisfy Snell's law. Thus, a boundary between the first lens layer 330 and the second lens layer 340 has to form the concave surface 330a, so that the light for the left eye image and the light for the right eye image are converged on the focus of the switchable lens device 300. On the contrary, when the boundary between the first lens layer 330 and the second lens layer 340 forms a convex surface, the light for the left eye image and the light for the right eye image are not converged on the focus of the switchable lens device 300. Hence, the light for the left eye image and the light for the right eye image are not separated.

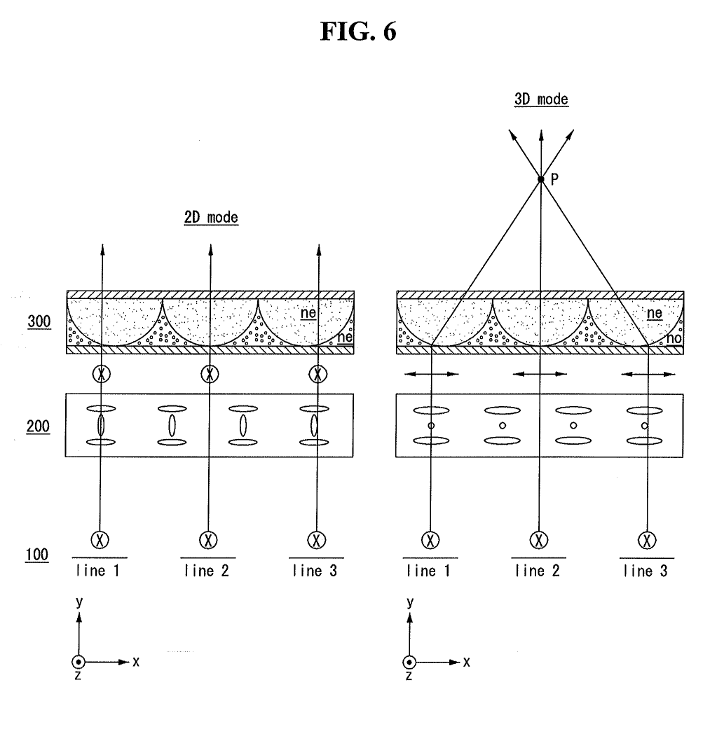

A process for displaying the 2D image and the 3D image through the 2D/3D image display device according to the embodiment of the invention is described below with reference to FIG. 6. FIG. 6 illustrates a principle to display the 2D image and the 3D image through the 2D/3D image display device according to the embodiment of the invention. FIG. 6 shows that the switchable lens device 300 is disposed correspondingly to pixels on three lines of the display panel 100.

In a 3D image mode, while light passes through the polarization control unit 200 to which an electric field is not applied, a polarization axis of the light rotates from the vertical direction ‘\hat{×}’ (z-axis direction in FIG. 6) to the horizontal direction ‘←’ (x-axis direction in FIG. 6) by 90°. Hence, light having a polarization axis of the horizontal direction ‘←’ is supplied to the switchable lens device 300.

Because the liquid crystal molecules configuring the first lens layer 330 of the lens cell LCC of the switchable lens device 300 are orientated in the vertical direction, a polarization direction of light incident on the first lens layer 330 is the same as the short axis direction of the liquid crystal molecules. Thus, the first lens layer 330 functions as a layer having the second refractive index ‘no’, and the second lens layer 340 functions as a layer having the first refractive index ‘ne’. Hence, according to Snell's law, light is refracted by the concave surface 330a of the first lens layer 330 and is converged on a focus ‘p’. As a result, while the light passes through the switchable lens device 300, the light is separated into a travelling path of light corresponding to the right eye image and a travelling path of light corresponding to the left eye image and is converged on different focuses, thereby displaying the 3D image.

In a 2D image mode, when light passes through the polarization control unit 200 to which the electric field is applied, the light passes through the polarization control unit 200 without a change in a polarization axis. Thus, before and after the light passes through the polarization control unit 200, the light has a polarization axis of the vertical direction ‘\hat{×}’ (z-axis direction in FIG. 6).

Hence, in the 2D image mode, the light having the polarization axis of the vertical direction ‘\hat{×}’ is supplied to the switchable lens device 300.

Because the liquid crystal molecules of the first lens layer 330 of the lens cell LCC of the switchable lens device 300 are orientated in the vertical direction, a polarization direction of light incident on the first lens layer 330 is the same as the long axis direction of the liquid crystal molecules. Thus, the first lens layer 330 functions as a layer having the first refractive index ‘ne’, and the second lens layer 340 functions as a layer having the first refractive index ‘ne’. Hence, light passes through the switchable lens device 300 while the light is not refracted by the switchable lens device 300, thereby displaying the 2D image.

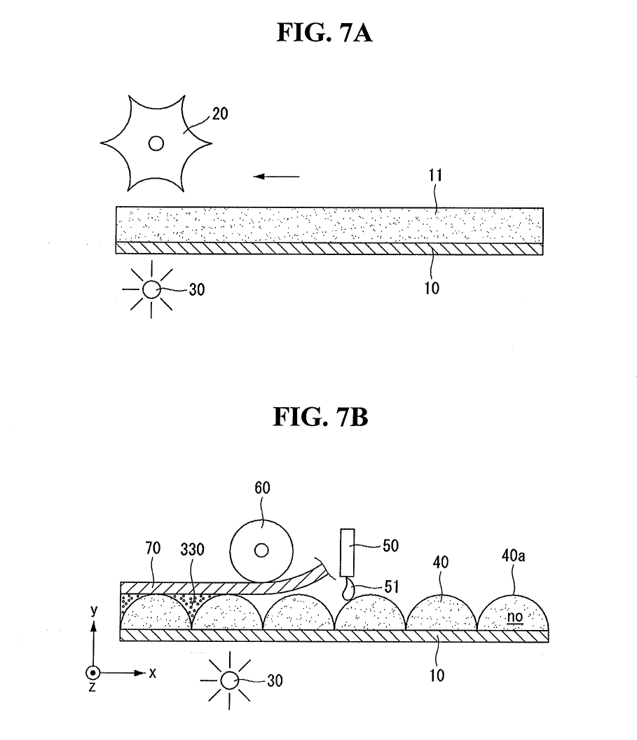

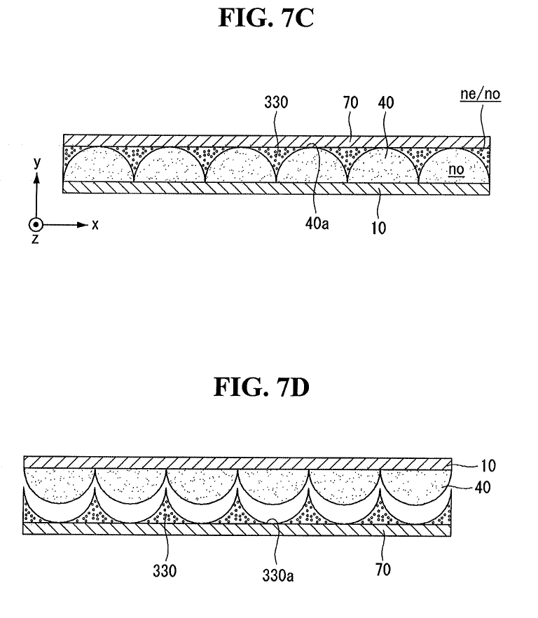

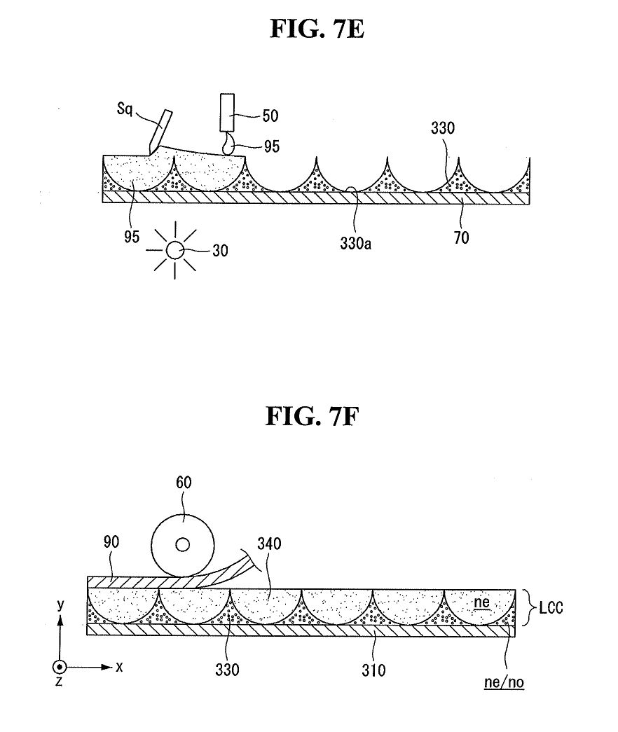

A method of manufacturing the switchable lens device 300 according to the embodiment of the invention is described below with reference to FIGS. 7A to 7F. FIGS. 7A to 7F illustrate an example of a method of manufacturing the switchable lens device according to the embodiment of the invention.

The refractive index of the second lens layer 340 of the switchable lens device 300 according to the embodiment of the invention is the same as the refractive index ‘ne’ in the long axis direction of the liquid crystal molecules configuring the first lens layer 330. Namely, a refractive index of the UV curable resin configuring the second lens layer 340 is the same as the refractive index ‘ne’ in the long axis direction of the liquid crystal molecules of the first lens layer 330. The liquid crystal molecules of the first lens layer 330 have the high refractive index of about 1.75 in the long axis direction. The high refractive index UV curable resins, which have been currently developed, uses a solvent as a menstruum.

The method of manufacturing the switchable lens device 300 generally includes forming an uneven surface (concave surface or convex surface) on the first lens layer 330 or the second lens layer 340 using a mold. However, when the uneven surface is formed using the mold, a material forming the uneven surface must not include a solvent because the solvent may dissolve the mold. Thus, it was impossible to form a convex surface on the second lens layer 340 of the high refractive index using the mold in a related art.

On the other hand, the method of manufacturing the switchable lens device 300 according to the embodiment of the invention makes it possible to form the second lens layer 340 of the high refractive index using the mold.

As shown in FIG. 7A, a UV curable resin 11 of a low refractive index is applied on a first base film 10 to a predetermined thickness. In the embodiment of the invention, the low refractive index is less than the refractive index ‘ne’ in the long axis direction of liquid crystal molecules forming reactive mesogen and may be the same as the refractive index ‘no’ in the short axis direction as an example.

Subsequently, convex surfaces 40a are formed on the UV curable resin 11 using a first mold 20, and at the same time, ultraviolet ray is irradiated onto the UV curable resin 11 using a lamp 30 to cure the UV curable resin 11.

As shown in FIG. 7B, a first refractive index layer 40 having the convex surfaces 40a is formed on the first base film 10, and then a reactive mesogen 51 is dispensed on the convex surfaces 40a using a dispenser 50. Further, a second base film 70 is attached on the reactive mesogen 51 using a roller 60. Next, linearly polarized UV ray is irradiated onto the reactive mesogen 51 to orient liquid crystal molecules of the reactive mesogen 51 in a desired initial orientation direction, and at the same time, the reactive mesogen 51 is cured. In the embodiment of the invention, the liquid crystal molecules may be arranged along a long-axis in a vertical direction (i.e., z-axis direction in the drawing).

As shown in FIG. 7C, a base panel in which the first refractive index layer 40 and the second base film 70 are disposed between the first and second base films 10 and 70 is obtained. The first refractive index layer 40 is formed of the UV curable resin 11 of the low refractive index ‘no’ and has the convex surfaces 40a, and the second refractive index layer 330 is formed by filling the reactive mesogen 51 between the convex surfaces 40a.

As shown in FIG. 7D, the first refractive index layer 40 and the first base film 10 are removed in the base panel. The convex surfaces 40a of the first refractive index layer 40 and the second refractive index layer 330 form a boundary. Because the first refractive index layer 40 and the second refractive index layer 330 are formed of different materials, they may be mechanically separated from each other. Alternatively, before the reactive mesogen 51 is applied on the first refractive index layer 40, a releasing agent may be applied on the first refractive index layer 40 to separate the first refractive index layer 40 and the second refractive index layer 330. Alternatively, only the first refractive index layer 40 may be selectively removed from the second refractive index layer 330 through a dry or wet etching method using a difference of an etching ratio.

As described above, a first lens layer 330 having a concave surface 330a may be formed on the second base film 70 by removing the first refractive index layer 40 and the first base film 10 in the base panel.

As shown in FIG. 7E, a high refractive index UV curable resin 95 is dispensed on the concave surface 330a in an ink form using the dispenser 50, and the concave surface 330a is planarized using a squeeze ‘Sq’. At the same time, UV ray is irradiated onto the dispensed high refractive index UV curable resin 95 using the lamp 30 to cure the high refractive index UV curable resin 95. In this instance, because the high refractive index UV curable resin 95 used in the embodiment of the invention is a material including a solvent and uses an inkjet printing method, the second lens layer 340 may be formed using the high refractive index UV curable resin 95.

As shown in FIG. 7F, after the high refractive index UV curable resin 95 is formed, a third base film 90 is attached to the second lens layer 340 using the roller 60. Hence, the switchable lens device 300 is manufactured.

The method of manufacturing the switchable lens device 300 according to the embodiment of the invention may include forming an uneven surface using a UV curable resin of the low refractive index ‘no’ on the reactive mesogen in the form of pattern transfer and then applying a high refractive index UV curable resin including a solvent on the uneven surface, instead of forming the uneven surface using the UV curable resin of the high refractive index ‘ne’ using the mold.

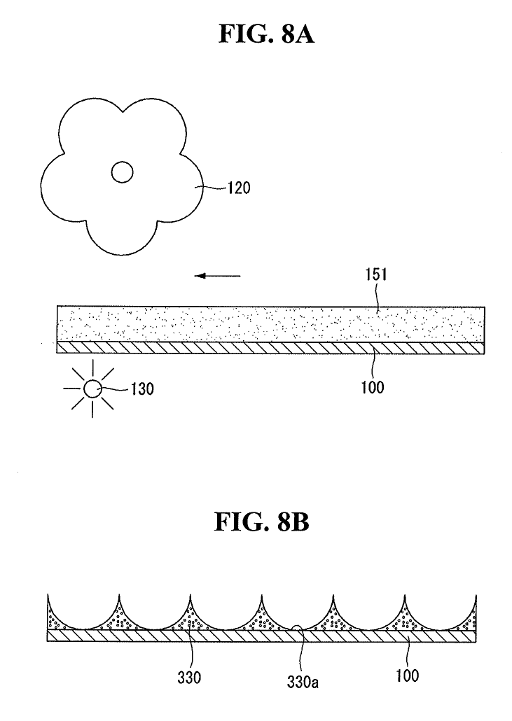

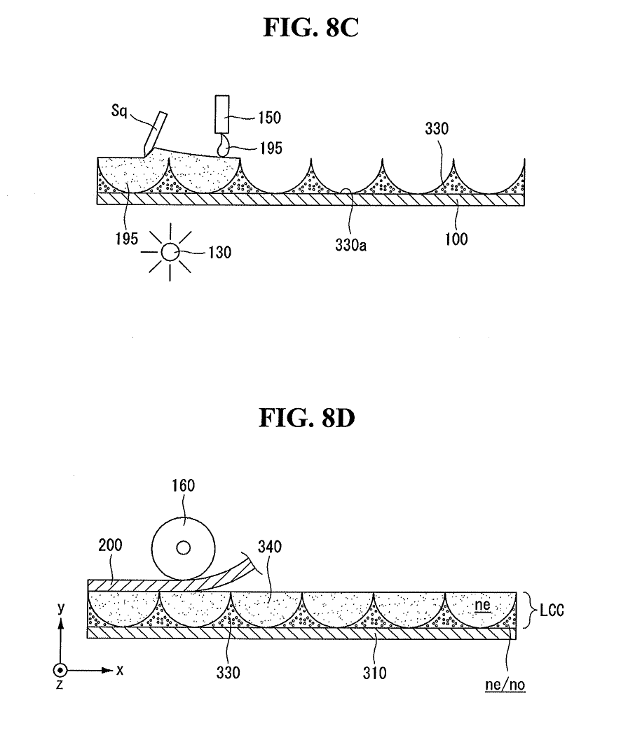

Another method of manufacturing the switchable lens device 300 according to the embodiment of the invention is described below with reference to FIGS. 8A to 8D. FIGS. 8A to 8D illustrate another example of a method of manufacturing the switchable lens device according to the embodiment of the invention.

As shown in. FIGS. 8A and 8B, a reactive mesogen 151 is applied on a first base film 100 to a predetermined thickness. A concave surface 330a is formed on the reactive mesogen 151 using a second mold 120, and at the same time, linearly polarized UV ray is irradiated onto the reactive mesogen 151 having the concave surface 330a to orient liquid crystal molecules of the reactive mesogen 151 in a desired initial orientation direction. At the same time, the reactive mesogen 151 is cured. In the embodiment of the invention, the liquid crystal molecules may be arranged along a long-axis in a vertical direction (i.e., z-axis direction in the drawing).

As shown in FIG. 8C, a high refractive index UV curable resin 195 is dispensed on the concave surface 330a in an ink form using a dispenser 150, and the concave surface 330a is planarized using a squeeze ‘Sq’. At the same time, UV ray is irradiated onto the dispensed high refractive index UV curable resin 195 using a lamp 30 to cure the high refractive index UV curable resin 195. In this instance, because the high refractive index UV curable resin 195 used in the embodiment of the invention is a material including a solvent and uses an inkjet printing method, the second lens layer 340 may be formed using the high refractive index UV curable resin 195.

As shown in FIG. 8D, after the high refractive index UV curable resin 195 is formed, a second base film 200 is attached to the second lens layer 340 using a roller 60. Hence, the switchable lens device 300 is manufactured.

The above-described method of manufacturing the switchable lens device according to the embodiment of the invention forms the uneven surface on the reactive mesogen and then applies the high refractive index UV curable resin including the solvent on the uneven surface, instead of forming the uneven surface using the UV curable resin of the high refractive index ‘ne’ using the mold. Hence, the switchable lens device may be manufactured.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A switchable lens device comprising:
a first base film;
a first lens layer which is formed on the first base film, has a first refractive index in a first direction, has a second refractive index less than the first refractive index in a second direction vertical to the first direction, and has concave surfaces;
a second lens layer which has convex surfaces filled in the concave surfaces of the first lens layer and has the first refractive index; and
a second base film attached to the second lens layer.

2. The switchable lens device of claim 1, wherein a volume of the first lens layer is less than a volume of the second lens layer.

3. The switchable lens device of claim 1, wherein the first base film is formed of a material having a low retardation equal to or less than about 100 nm, and isotropic and uniaxial characteristics.

4. The switchable lens device of claim 1, wherein the first lens layer is formed of a ultraviolet (UV) curable liquid crystal material, which is reactive mesogen having refractive index anisotropy, and the second lens layer is formed of a UV curable resin.

5. A 2-dimensional (2D) and 3-dimensional (3D) image display device comprising:
a display panel configured to display an image using light linearly polarized in a first direction;
a polarization control unit configured to selectively switch light of the first direction to light linearly polarized in a second direction vertical to the first direction; and
a switchable lens device configured to refract light incident from the polarization control unit using a difference of a refractive index and separate the refracted light into light for a left eye image and light for a right eye image to implement a 3D image, or transmit the light incident from the polarization control unit without a change to implement a 2D image.

6. A method of manufacturing a switchable lens device comprising:
forming a first lens layer, which has a first refractive index in a first direction, has a second refractive index less than the first refractive index in a second direction vertical to the first direction, and has concave surfaces, on a first base film;
filling a second lens layer having the first refractive index in the concave surfaces of the first lens layer to form convex surfaces; and
forming a second base film on the second lens layer.

7. The method of claim 6, wherein the forming of the first lens layer includes:
applying a low refractive index ultraviolet (UV) curable resin on a substrate to form a first layer having convex surfaces using a first mold;
applying reactive mesogen having refractive index anisotropy on the convex surfaces of the first layer to form a second layer;
irradiating linearly polarized UV ray onto the second layer to orient liquid crystal molecules of the reactive mesogen and at the same time to cure the liquid crystal molecules;
attaching a first base film to the second layer to form a base panel; and
removing the first layer and the substrate from the base panel to form the first lens layer on the first base film.

8. The method of claim 6, wherein the forming of the first lens layer includes:
applying reactive mesogen having refractive index anisotropy on a first base film;
forming a first layer having concave surfaces using a second mold; and
irradiating linearly polarized UV ray onto the first layer, orienting liquid crystal molecules of the reactive mesogen, and at the same time, curing the liquid crystal molecules to form the first lens layer.

9. The method of claim 7, wherein the forming of the second lens layer includes:
applying a high refractive index UV curable resin on the first lens layer having the concave surfaces using a dispenser and then curing the high refractive index UV curable resin; and
planarizing the high refractive index UV curable resin.

10. The method of claim 8, wherein the forming of the second lens layer includes:
applying a high refractive index UV curable resin on the first lens layer having the concave surfaces using a dispenser and then curing the high refractive index UV curable resin; and
planarizing the high refractive index UV curable resin.

11. The method of claim 9, wherein the high refractive index UV curable resin includes a solvent.

12. The method of claim 7, wherein the forming of the second lens layer includes irradiating linearly polarized UV ray onto reactive mesogen to orient liquid crystal molecules of the reactive mesogen in a linearly polarized direction.
